(19) United States
(12) Patent Application Publication
(10) Pub. No.: US 2011/0216863 A1
(43) Pub. Date: Sep. 8, 2011

(54) RECEIVING APPARATUS AND METHOD FOR SETTING GAIN

(75) Inventors: Masato TOMITA, Kasugai (JP); Hideaki WATANABE, Kasugai (JP)

(73) Assignee: FUJITSU SEMICONDUCTOR LIMITED, Yokohama-shi (JP)

(21) Appl. No.: 13/022,992

(22) Filed: Feb. 8, 2011

(30) Foreign Application Priority Data
Mar. 4, 2010 (JP) 2010-48138

(51) Int. Cl. H04L 7/00

(52) U.S. Cl. 375/371

(57) ABSTRACT

A receiving apparatus includes: a clock-data recovery circuit to generate a clock based on receive data and a setting circuit to set a gain of a filtering process to filter a phase difference between the receive data and the clock.

### CROSS-REFERENCE TO RELATED APPLICATIONS

This application claims the benefit of priority from Japanese Patent Application No. 2010-48138 filed on Mar. 4, 2010, the entire contents of which are incorporated herein by reference.

### BACKGROUND

1. Field

Embodiments discussed herein relate a receiving apparatus and a gain-setting method, respectively.

2. Description of Related Art

A high-speed serial interface may employ a clock-data recovery system for transmitting data with superimposed clock. The receiving apparatus, which employs the clock-data recovery system, includes a clock-data recovering (CDR) circuit that extracts a clock synchronized with the received data.

Related art is disclosed in Japanese Laid-open Patent Publication No. 2005-150890, Japanese Laid-open Patent Publication No. 2008-236735, and so on.

### SUMMARY

According to one aspect of the embodiments, a receiving apparatus includes: a clock-data recovery circuit to generate a clock based on receive data and a setting circuit to set a gain of a filtering process to filter a phase difference between the receive data and the clock.

The object and advantages of the invention will be realized and attained at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates an exemplary receiving apparatus;

FIG. 2 illustrates an exemplary filter circuit;

FIG. 3 illustrates an exemplary method for setting gain parameters;

FIG. 4A to FIG. 4F illustrate exemplary characteristics of a CDR circuit, respectively;

FIG. 5 illustrate an exemplary a receiving apparatus;

FIG. 6 is illustrates an exemplary gain parameter setting;

FIG. 7 illustrates an exemplary gain parameter setting;

FIG. 8 illustrates an exemplary gain parameter setting;

FIG. 9 illustrates an exemplary receiving apparatus;

FIG. 10 illustrates an exemplary receiving apparatus;

FIG. 11 illustrates an exemplary jitter circuit;

FIG. 12 illustrates an exemplary jitter measurement circuit;

FIG. 13 illustrates an exemplary jitter measurement circuit;

FIG. 14 illustrates an exemplary gain parameter setting; and

FIG. 15 illustrates an exemplary jitter measurement.

### DESCRIPTION OF EMBODIMENTS

Since a CDR circuit adjusts response sensitivity in response to a difference in phase difference, the response sensitivity is set to low when the phase difference amount is small, for example. If the amount of jitter of receive data is large, the receive data may be not received normally. If the amount of phase difference is large, the response sensitivity is set to high. If the jitter amount of receive data is small, the phase varies and a clock may become unstable.

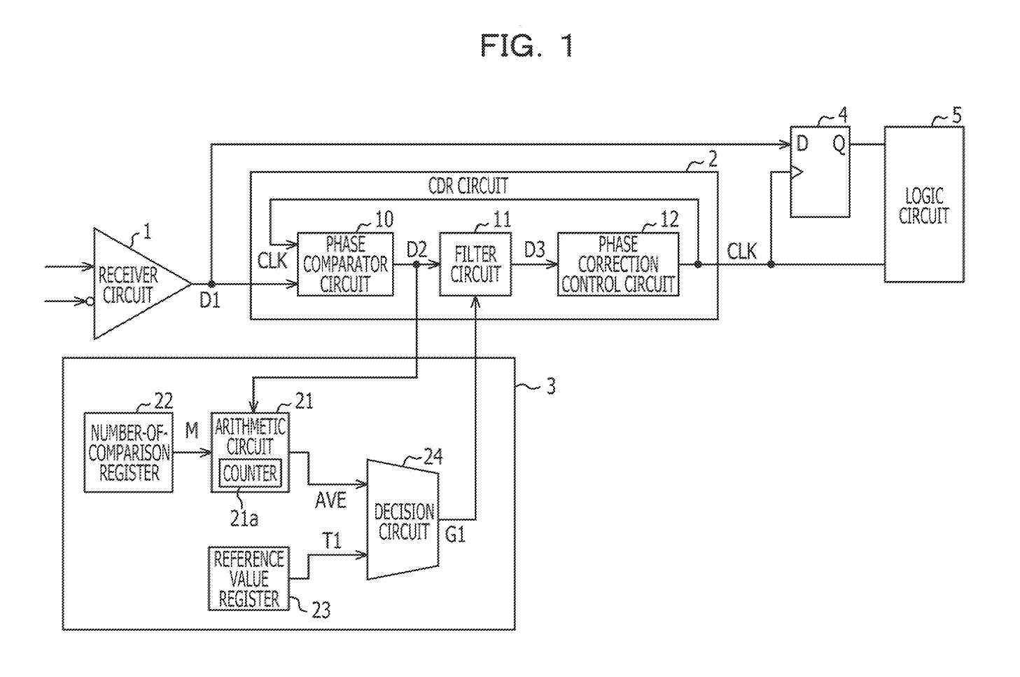

FIG. 1 illustrates an exemplary receiving apparatus. The receiving apparatus includes a receiver circuit 1, a clock-data recovery circuit (CDR circuit) 2, a gain setting circuit 3, a D-flip-flop circuit (D-FF circuit) 4, and a logic circuit 5.

The receiving circuit 1 receives differential serial data from a transmitting apparatus (not shown). The receiving circuit 1 generates binarized serial data D1 by determining a high level or a low level of received differential serial data and outputs the serial data D1 to the CDR circuit 2 and the D-FF circuit 4.

The CDR circuit 2 generates an extraction clock CLK which is extracted from serial data (receive data) D1. The extraction clock CLK may be a clock that synchronizes with the receive data D1. The CDR circuit 2 outputs the extraction clock CLK to the D-FF circuit 4 and the logic circuit 5.

The gain setting circuit 3 determines a gain parameter (gain) G1 of a filter circuit 11 in the CDR circuit 2 depending on the amount of jitter of the receive data D1. If the gain parameter G1 is changed, the tracking characteristic to the receive data D1 of the CDR circuit 2 may be changed. The gain setting unit 3 may set the tracking characteristic of the CDR circuit 2 depending on the jitter amount of the receive data D1.

The receive data D1 is input from the receiver circuit 1 to the data terminal of the D-FF circuit 4, and the extraction clock CLK is input from the CDR circuit 2 to the clock terminal of the D-FF circuit 4. The D-FF circuit 4 samples the receive data D1 in synchronization with the leading edge of the extraction clock CLK and outputs the sampled data as retiming data to the logic circuit 5.

The logic circuit 5 may execute various kinds of processes based on the retiming data from the D-FF circuit 4 or the extraction clock CLK from the CDR circuit 2.

The CDR circuit 2 includes a phase comparator circuit 10, a filter circuit 1, and a phase correction control circuit 12. The phase comparison circuit 10 compares the phase of the receive data D1 with the phase of the extraction clock CLK fed back from the phase correction control circuit 12 to generate phase difference information D2 indicating the phase difference between the receive data D1 and the extraction clock CLK. The phase comparison circuit 10 outputs the phase difference information D2 to the filter circuit 11 and the gain setting unit 3. The phase comparator circuit 10 detects a phase lead or a phase delay between the receive data D1 and the extraction clock CLK extracted from the receive data D1. According to a result of the detection, the phase comparator circuit 10 sets +1 in the case of phase lead or sets −1 in the case of phase delay. An adder in the phase comparator circuit 10 sums up the set data for cycles of the extraction clock CLK, for example 10 cycles thereof. Then, the sum is output as digital phase difference information D2, for example a phase code, to the filter circuit 11 and the gain setting circuit 3. A period corresponding to the cycles may be set based on a communication rate or the like.

The filter circuit 11 generates a phase control code D3 by progressive-averaging (filtering) of the phase difference information D2 and outputting a phase control code D3 to the phase correction control circuit 12. The filter circuit 11 sets response sensitivity based on a gain parameter G1 set by the gain setting circuit 3. The response sensitivity of the filter circuit 11 is reflected on the tracking characteristic of the CDR circuit 2. The tracking characteristic of the CDR circuit 2 may be determined based on the gain parameter G1 of the filter circuit 11.

The phase correction control circuit 12 generates an extraction clock CLK having an arbitrary phase of 0 to 2π based on the phase control code D3. For example, the phase correction control circuit 12 determines the phase of the extraction clock CLK based on the phase correction control code D3. For example, if the phase control code D3 includes 64 different codes, the phase correction control circuit 12 generates a clock corresponding to one phase among phases, which are generated by dividing a phase of 0 to 2π, as an extraction clock CLK. The CDR circuit 2 feeds back the extraction clock CLK to the phase comparator circuit 10. The extraction clock CLK and the receive data D1 are compared and the phase of the extraction clock CLK is controlled.

The CDR circuit may include a phase locked loop (PLL). The phase comparator circuit 10, the filter circuit 11, and the phase correction control circuit 12 generate the extraction clock CLK based on the receive data D1. The PLL may include an oscillator circuit for generation of extraction clock CLK, such as a voltage-controlled oscillator (VCO). The phase correction control circuit 12 determines the phase of the extraction clock CLK in response to an output of the filter circuit 11.

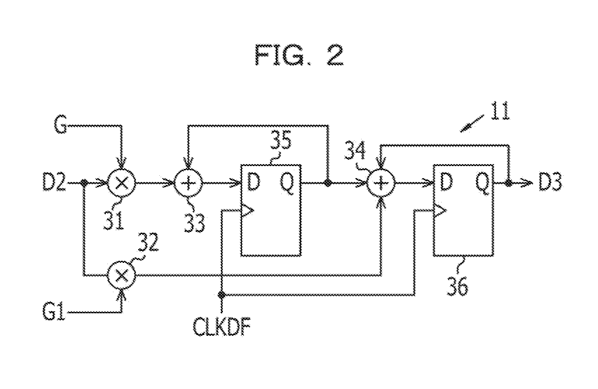

FIG. 2 illustrates an exemplary filter circuit. The filter circuit 11 illustrated in FIG. 2 may be a digital filter. The filter circuit 11 includes multipliers 31 and 32, adders 33 and 34, and D-FF circuits 35 and 36.

The multiplier 31 receives phase difference information D2 and a gain parameter G as inputs from the phase comparator circuit 10. The multiplier 31 outputs a multiplied value obtained by multiplying the phase difference information D2 by the gain parameter G to the adder 33. The adder 33 adds an output signal from the D-FF circuit 35 to the multiplied value from the multiplier 31 and outputs the added value to a data terminal of the D-FF circuit 35. A frequency-divided clock signal CLKDF, which is obtained by dividing the extraction clock CLK for a number of cycles, for example 10 cycles, is supplied to the clock terminal of the D-FF circuit 35. The D-FF circuit 35 outputs the added value to the adders 33 and 34 in synchronized with the clock signal CLKDF.

The phase difference information D2 from the phase comparator circuit 10 and a gain parameter G1, which is set by the above gain setting circuit 3, are input to the multiplier 32. The multiplier 32 multiplies the phase difference information D2 by the gain parameter G1 and outputs the multiplied value to the adder 34.

An output signal from the D-FF circuit 36 and the multiplied value from the multiplier 32 are input to the adder 34. In addition, an output signal from the D-FF cycle 35 is also input to the adder 34. The adder 34 adds output signals from the D-FF circuits 35 and 36 to the multiplied value from the multiplier 32 and outputs the added value to the data terminal of the D-FF circuit 36. The clock signal CLKDF is input to the clock terminal of the D-ff circuit 66. The D-FF circuit 36 outputs the added value from the adder 34 to the phase correction control circuit 12 as the above phase control code D3 in synchronized with the clock signal CLKDF.

The filter circuit 11 illustrated in FIG. 2 generates the phase control code D3 by progressive-averaging the phase difference D2 for cycles of the extraction clock CLK, for example 10 cycles, according to response sensitivity set by the gain parameters G and G1. If the gain parameter G1 set by the gain setting circuit 3 is large, the response sensitivity of the filter circuit 11 may become large. The tracking characteristic of the CDR circuit 2 may also become large. In the filter circuit 11, the multiplied value of the multiplier 32 varies depending on the gain parameter G1 and the phase control code D3 also varies. For example, even if the phase difference information D2 to be input to the filter circuit 11 is not changed, the more the gain parameter G1 increases the more the phase control code D3 increases. In the phase correction control circuit 12, the amount of phase variation of the extraction clock CLK per phase control becomes large. Therefore, the more the gain parameter G1 of the filter circuit 11 increases the more the tracking characteristic of the CDR circuit 2 increases. The more the gain parameter G1 of the filter circuit 11 decreases the more the tracking characteristic of the CDR circuit 2 becomes small.

The gain setting circuit 3 illustrated in FIG. 1 monitors the amount of phase difference between the receive data D1 and the extraction clock CLK, detects the jitter amount of the received data D1 for the gain parameter G1, and sets the gain parameter G1 depending on the detected jitter amount. If the amount of phase difference is equal to or more than a reference value, then the gain setting circuit 3 changes the gain parameter G1 so that the phase difference becomes small based on an initial value of the gain parameter G1. The gain setting unit 3 includes an arithmetic circuit 21, a number-of-comparison register 22, a reference value register 23, and a decision circuit 24.

The phase difference information D2 from the phase comparator circuit 10 and a determination number M from the number-of-comparison register 22 are input to the arithmetic circuit 21. The arithmetic circuit 21 calculates the average value AVE of determination number M pieces of the phase difference information D2, for example 10 pieces, and outputs the average value AVE to the decision circuit 24. The arithmetic circuit 21 may determine whether the number phase comparisons reaches to the determination number M based on the count operation of a built-in counter 21a.

The reference value register 23 stores the reference value T1 of the amount of phase difference, which may be previously set. Then, the gain parameter G1 may be changed based on the reference value T1 and the average value AVE of the phase difference information D2.

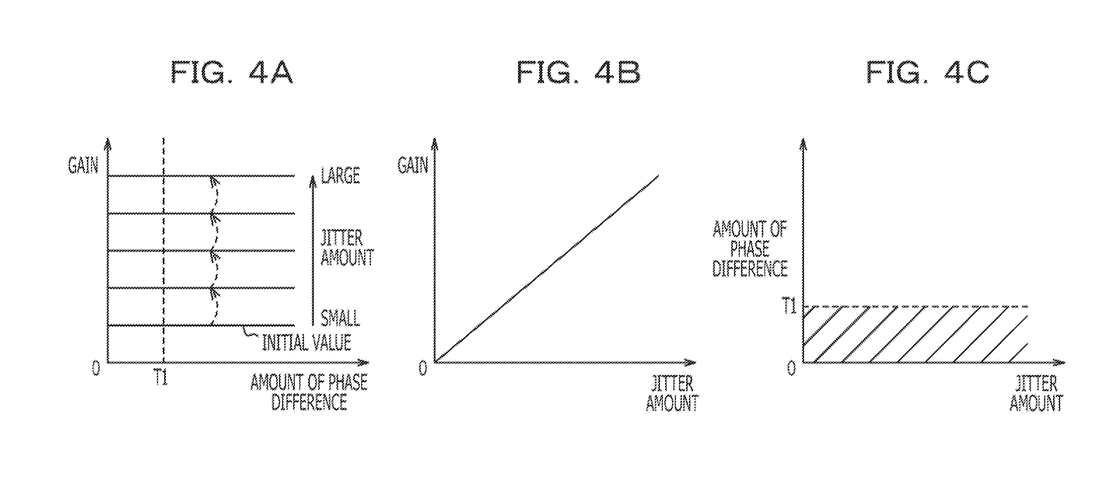

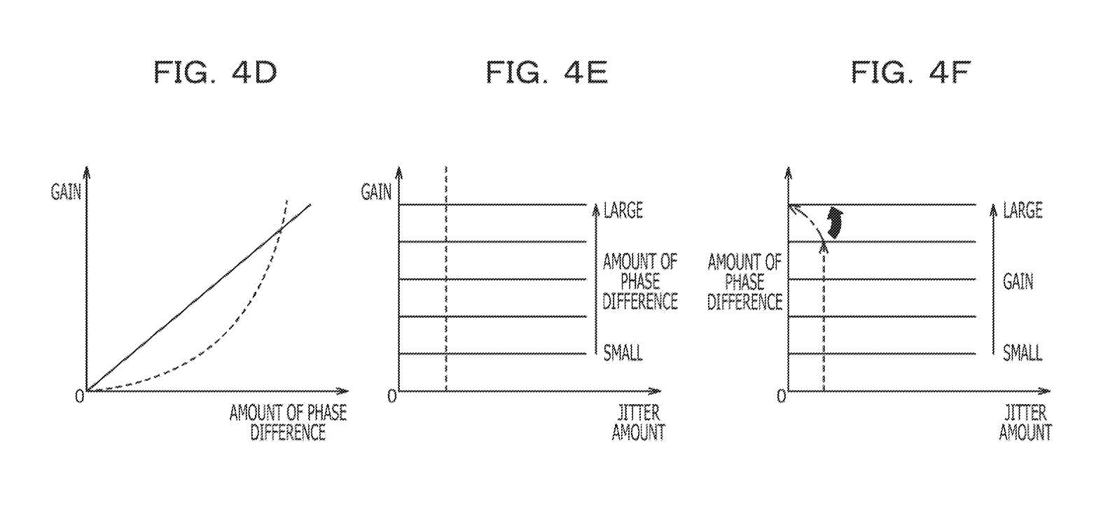

The decision circuit 24 sets the gain parameter G1 of the filter circuit 11 based on the result of the comparison between the average value AVE of the phase difference information D2 and the reference value T1 from the reference value register 23. The decision circuit 24 does not change the gain parameter G1 when the average value AVE is less than the reference value T1. The decision circuit 24 changes the gain parameter G1 so as to make the average value AVE smaller when the average value AVE is equal to or more than the reference value T1. The decision circuit 24 outputs the gain parameter G1 to the filter circuit 11. For example, the initial value of the gain parameter G1 may be a small value enough to cause tracking characteristic of the CDR circuit 2 to reduce (see FIG. 4A).

The phase difference between the receive data D1 output from the phase comparator circuit 10 and the extraction clock CLK, for example the phase difference information D2, may increase when the relation between the jitter amount of the receive data D1 and the tracking characteristic of the CDR circuit 2 set by the gain parameter G1 is not appropriate. If the gain parameter G1 is small while the jitter amount of the receive data D1 is large, for example, if the tracking characteristic of the CDR circuit 2 is small, the phase difference information D2 may increase. If the gain parameter G1 is large while the jitter amount of the receive data D1 is small, for example, if while the tracking characteristic of the CDR circuit 2 is large, the phase difference information D2 may increase.

The decision circuit 24 determines whether the average value AVE of the phase difference information D2 is not less than the reference value T1 and determines whether the relation between the jitter amount of the receive data D1 and the tracking characteristic of the CDR circuit 2 determined by the gain parameter G1 is appropriate. Since the initial value of the gain parameter G1 is set as a small one, it may be detected that the jitter amount of the received data D1 is large when the average value AVE of the phase difference information D2 becomes equal to or more than the reference value T1. For example, since the jitter amount of the receive data D1 is large with respect to the initial value of the smaller gain parameter G1, the average AVE may be determined to be equal to or more than the reference value T1 or more. The decision circuit 24 increases the gain parameter G1 to make the average value AVE smaller when the average value AVE is equal to and more than the reference value T1. Therefore, the tracking characteristic of the CDR circuit 2 becomes large, and the tracking characteristic of the CDR circuit 2 may be appropriately set for the jitter amount of the receive data D1.

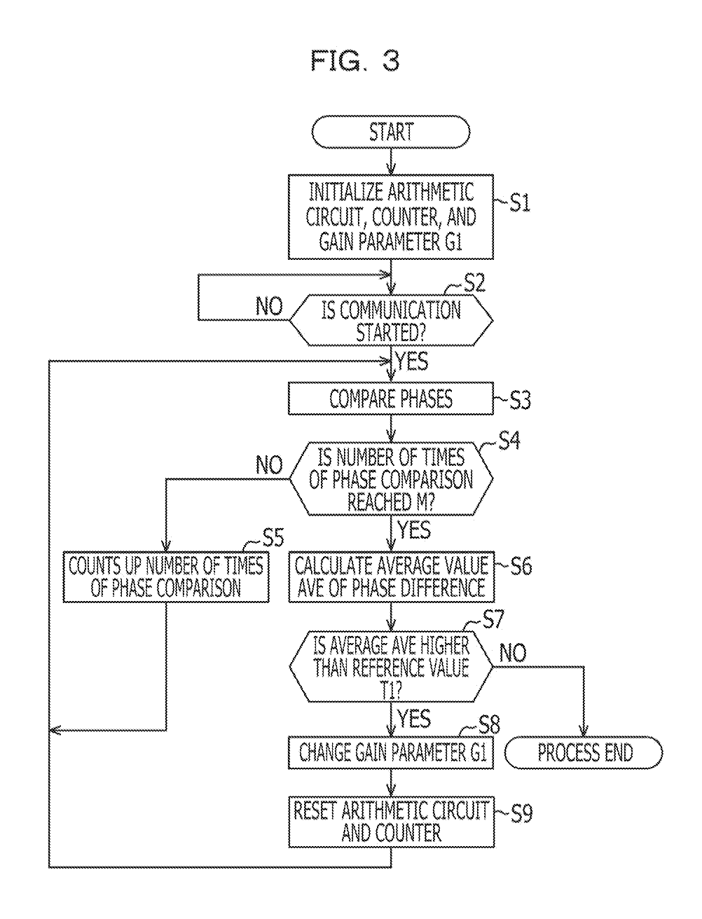

FIG. 3 illustrates an exemplary method for setting a gain parameter. FIG. 4A to FIG. 4F illustrates exemplary characteristics of a CDR circuit. The setting method illustrated in FIG. 3 may be performed by the receiving apparatus illustrated in FIG. 1. Before communication begins, in an operation S1, the arithmetic circuit 21, counter 21a, and gain parameter G1 are initialized. The initial value of the gain parameter G1 may be set to a low value so that the tracking characteristic of the CDR circuit 2 may become small. The process waits for the start of communication. If the communication begins (“YES” in an operation S2), the phase comparator circuit 10 compares the phase of the receive data D1 with the phase of the extraction clock CLK in an operation S3.

If a number of times of phase comparison is less than the number M (“NO” in an operation S4), the counter 21a counts up in an operation S5 and the process returns to operation S3. If the number of times of phase comparison reaches the number M (“YES” in the operation S4), the arithmetic circuit 21 calculates the average value AVE of M pieces of difference information D2 (amounts of phase difference) in an operation S6.

In an operation S7, the decision circuit 24 determines whether the average value AVE is equal to or more than the reference value T1. In the operation S7, it is determined whether the current gain parameter G1 for the jitter amount of the receive data D1, for example an initial value, is suitable. If the average value AVE is equal to or more than the reference value T1, the decision circuit 24 determines that the jitter amount of the received data D1 for the initial value of the gain parameter G1 is large. For example, it is determined that the gain parameter G1 for the jitter amount of the receive data D1 is small.

Since the initial value of the gain parameter G1 is set to a small value and the average value AVE of the phase difference information D2 is monitored as a jitter amount, it is determined that the relation between the defined gain parameter G1 and the jitter amount of the receive data D1 is appropriate. The initial value of the gain parameter G1 is small, the phase difference information D2 varies in proportion to an increase in jitter amount of the receive data D1, and the phase difference information D2 is monitored as a jitter amount of the receive data D1. Since the initial value of the gain parameter G1 is set to a small value, the more the jitter of the receive data D1 increases the more the phase difference information D2 increases, and the more the jitter of the receive data D1 decreases the more the phase difference information D2 decreases. When the average value AVE is equal to or more than the reference value 1, it is determined that the jitter amount of the received data D1 for the initial value of the gain parameter G1 is large. For example, it is determined that the gain parameter G1 for the jitter amount of the receive data D1 is small.

If the average value AVE is equal to or more than the reference value T1 (“YES” in the operation S7), the decision circuit 24 increases the gain parameter G1 as represented by the dashed arrow in FIG. 4A to enhance the tracking characteristic of the CDR circuit 2 in an operation S8. Since the tracking characteristic of the CDR circuit 2 approaches a suitable value for the jitter amount of the receive data D1, the phase difference between the receive data D1 and the extraction clock CLK, for example the average value AVE, may become small. The decision circuit 24 changes the gain parameter G1 to make the average value AVE smaller when the average value AVE is equal to and more than the reference value T1. In an operation S9, the arithmetic circuit 21 and the counter 21a are reset. Then the process returns to the operation S3.

The operations S3 to S6 are performed again to calculate the phase difference between the receive data D1 and the extraction clock CLK, which is generated according to the tracking characteristic of the CDR circuit 2 based on the gain parameter G1 changed in the operation S8, for example, the average value AVE of the phase difference information D2 is calculated. In the operation S7, it is determined whether the calculated average value AVE is equal to or more than the reference value T1. For example, it is determined whether the relation between gain parameter G1 changed in the operation S8 and the jitter amount of receive data D1 is appropriate. When the average value AVE is equal to and more than the reference value T1, the decision circuit 24 determines that the relation between the gain parameter G1 and the jitter amount of the received data D1 is not appropriate because the jitter amount of the receive data D1 is larger than the current gain parameter G1. In the operation S8, the decision circuit 24 increases the gain parameter G1 such as one represented by the dashed arrow illustrated in FIG. 4A so that average value AVE of the phase difference information D2 becomes small.

The operations S3 to S9 are repeated until the average value AVE of the phase difference becomes less than the reference value T1 in the operation S7. The calculation of the average value AVE of the amounts of phase difference in the operations S3 to S6, the comparison between the average value AVE and the reference value T1 in the operation S7, or the increase in gain parameter G1 in the operations S8 and S9 may be repeated. A series of these operations causes the gain parameter G1 to increase gradually. Thus, the tracking characteristic of the CDR circuit 2 gradually approaches the suitable value for the jitter amount of the receive data D1, and the average value AVE of the phase difference gradually decreases.

If the average value AVE becomes smaller than the reference value T1 (“NO” in the operation S7), the decision circuit 24 determines that the relation between the gain parameter G1 and the jitter amount of the receive data D1 is appropriate. The process is ended without a change in gain parameter G1. A suitable gain parameter G1 is set depending on the jitter amount of the receive data D1 and an appropriate tracking characteristic of the CDR circuit 2 for the jitter amount of the receive data D1 is determined. For example, as illustrated in FIG. 4B, the more the jitter amount of the receive data D1 increases the larger the gain parameter G1 is set. When the gain parameter G1 is set depending on the jitter amount of the receive data D1, the average value AVE of the phase differences becomes smaller than the reference value T1 (refer to the hatching portion in the figure) regardless of the jitter amount of the receive data D1.

As illustrated in FIG. 4D, the response sensitivity, for example the gain, is associated with the phase difference between the receive data D1 and the extraction clock CLK. For example, as illustrated in FIGS. 4E and 4F, the gain is set depending on the phase difference regardless of the jitter amount of received data. For example, as represented by the dashed line in FIG. 4E, when the jitter amount of the receive data is substantially constant, the gain varies with a variation in the phase difference. For example, as represented by the dashed line in FIG. 4F, if the gain is set to large when the jitter amount of the receive data is small so that the phase difference becomes large, the gain may be set to be still larger depending on the phase difference as represented by the thick line in FIG. 4F.

In the gain setting circuit 3 illustrated in FIG. 1, the gain parameter G1 of the filter circuit 11 in the CDR circuit 2 may be set depending on the jitter amount of the receive data D1. The gain parameter G1 corresponding to the jitter amount of receive data D1 may be set. The tracking characteristic of the CDR circuit 2 corresponding to the jitter amount of the receive data D1 may be set. The receive data D1 is normally received regardless of the jitter amount, so that the receiving characteristic (jitter tolerance) may be improved.

The phase difference between the receive data D1 and the extraction clock CLK is monitored as a jitter amount, and the gain parameter G1 of the filter circuit 11 is set depending on the amount of phase difference. For example, since the gain parameter G1 is set based on the phase difference information D2 generated by the phase comparator circuit in a CDR circuit, a circuit size may be reduced.

The phase difference between the receive data D1 and the extraction clock CLK is monitored as a jitter amount, and the gain parameter G1 is changed so that the phase difference becomes small depending on the initial value of the gain parameter G1. When the relation between the jitter amount of the receive data D1 and the gain parameter G1, such as the tracking characteristic of the CDR circuit 2, is appropriate, the phase difference may become small. Therefore, when the gain parameter G1 is changed so that the phase difference becomes small, the gain parameter G1 is set to an appropriate value for the jitter amount of the gain parameter G1.

Since the initial value of the gain parameter G1 is set so that the tracking characteristic of the CDR circuit 2 becomes small, the phase difference information D2 may be changed in proportion to the jitter amount of the receive data D1. Therefore, the phase difference information D2 is monitored as the jitter amount of the receive data D1.

The average value AVE of the phase difference information D2 is compared with the reference value T1. Compared with the case where the phase difference information D2 is compared with the reference value T1, the accuracy of control of the gain parameter G1 may be improved. For example, the phase difference information D2 is compared with the reference value T1, the gain parameter G1 is changed when the phase difference information D2 is larger than the reference value T1. When the average value AVE is used, the gain parameter G1 may not be changed when the phase difference information D2 is larger than the reference value T1.

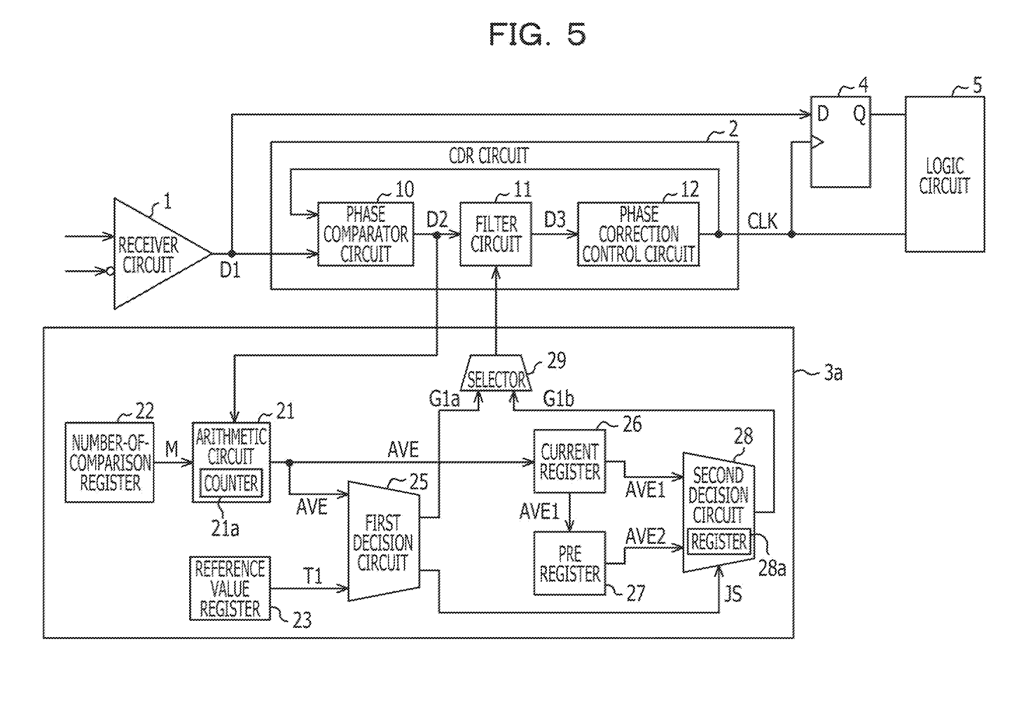

In FIGS. 5 to 8, the elements which are substantially the same as or similar to the elements illustrated in FIGS. 1 to 4 may be provided with the same reference numerals and the descriptions may be omitted or reduced.

FIG. 5 illustrates an exemplary receiving apparatus. As illustrated in FIG. 5, a gain setting circuit 3a includes an arithmetic circuit 21, a number-of-comparison register 22, a reference value register 23, a first decision circuit 25, a current register 26, a pre register 27, a second decision circuit 28, and a selector 29.

The gain setting circuit 3a monitors the phase difference between the receive data D1 and the extraction clock CLK, detects the jitter amount of the received data D1 for the gain parameter G1, and sets the gain parameter G1 depending on the detected jitter amount. If the jitter amount of the receive data D1 varies depending on the operational state or the like of the apparatus, the gain setting circuit 3a sets the gain parameter G1 depending on the varied jitter amount. When the phase difference is equal to or more than the reference value T1, the gain setting circuit 3a changes the gain parameter G1 so that the phase difference becomes small based on a change in the phase difference before and after the change of the gain parameter G1.

The arithmetic circuit 21 outputs the average value AVE of the phase difference information D2 and outputs the average value AVE to a first decision circuit 25 and the current register 26. The first decision circuit 25 sets a gain parameter G1a based on the result of the comparison between the average value AVE of the phase difference information D2 and the reference value T1 from the reference value register 23. In addition, the first decision circuit 25 outputs the gain parameter G1 to the filter circuit 11. For example, the decision circuit 25 changes the gain parameter G1a when the average value AVE is equal to or more than the reference value T1, while the decision circuit 25 does not change the gain parameter G1a when the average value AVE is less than the reference value T1. The first decision circuit 25 outputs a decision signal JS representing whether the average value AVE is equal to or more than the reference value T1. The initial value of the gain parameter G1a may be set to any value, for example, the center value of a setting range.

The current register 26 holds the average value AVE of the phase difference information D2. The current register 26 may hold the previous average value AVE. Every time the arithmetic circuit 21 calculates the average value AVE, the calculated average value AVE is written in the current register 26. The current register 26 outputs the average value AVE as an average value AVE1 to the pre register 27 and the second decision circuit 28.

The pre register 27 holds the average value AVE of the phase difference information D2. The pre register 27 may hold the average value AVE of the previous phase difference information D2. Every time the arithmetic circuit 21 calculates the average value AVE, the current average value AVE1 output from the current register 26 is written in the pre register 27. The pre register 27 outputs the average value AVE1, for example the previous average value AVE, as a pre average value AVE2 to the pre register 27 and the second decision circuit 28.

The second decision circuit 28 sets the gain parameter G1b based on a decision signal JS from the first decision circuit 25, a current average value AVE1, and the previous control information of the gain parameter G1. The second decision circuit 28 outputs the set gain parameter G1b to the selector 29. The second decision circuit 28 includes a register 28a that holds the previous control information indicating how the gain parameter G1, such as the gain parameter G1a or G1b, is controlled at the previous time.

The second decision circuit 28 sets the gain parameter G1b depending on the jitter amount of the receive data D1 being changed. For example, the second decision circuit 28 does not change the gain parameter G1b when the gain parameter G1 is appropriately set depending on the jitter amount of the receive data D1. The second decision circuit 28 may not change the gain parameter G1b when the decision signal JS, which represents that the average value AVE (current average value AVE1) is less than the reference value T1, is input.

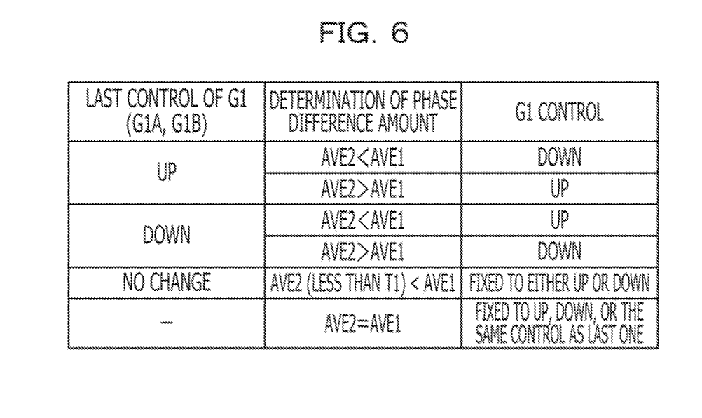

If the gain parameter G1 is not appropriately set depending on the jitter amount of the receive data D1, the second decision circuit 28 changes the gain parameter G1b depending on the phase difference information D2 (jitter amount) so that the phase difference information D2 becomes small. For example, when a decision signal JS, which represents that the average value AVE is equal to or more than the reference value T1, is input, the second decision circuit 28 increases or decreases gain parameter G1b based on the result of the comparison between the current average value AVE1 and the pre average value AVE2 and the previous control information of the gain parameter G1, as illustrated in FIG. 6. The control of increasing the gain parameter G1a or G1b may be referred to as an UP change. The control of decreasing the gain parameter G1 may be referred to as a DOWN change.

The selector 29 illustrated in FIG. 5 selects either the gain parameter G1a from the first decision circuit 25 or the gain parameter G1b from the second decision circuit 28 and the selected parameter is output as a gain parameter G1 to the filter circuit 11. For example, the selector 29 may select the gain parameter G1a for the first change control after starting the communication and may select the gain parameter G1b for the second or later change control after starting the communication. The gain parameter G1a may be used for a first change of the gain parameter G1 after starting the communication. The gain parameter G1b may be used for a second or later change of the gain parameter G1 after starting the communication.

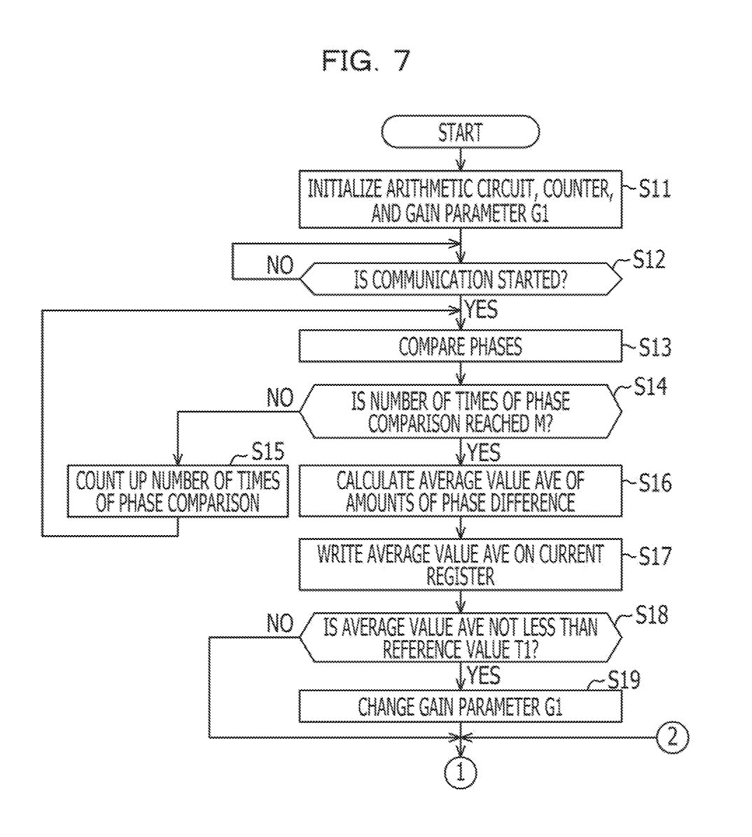

FIGS. 6 to 8 illustrate an exemplary setting a gain parameter. The setting the gain parameter illustrated in FIGS. 6 to 8 may be performed by the receiving apparatus illustrated in FIG. 5. For example, operations S11 to 516 illustrated in FIG. 7 may be substantially the same as or similar to the operations S1 to S6 illustrated in FIG. 3. For example, in the operation 516, the arithmetic circuit 21 may do a first calculation of the average value AVE of the phase difference information after starting the communication.

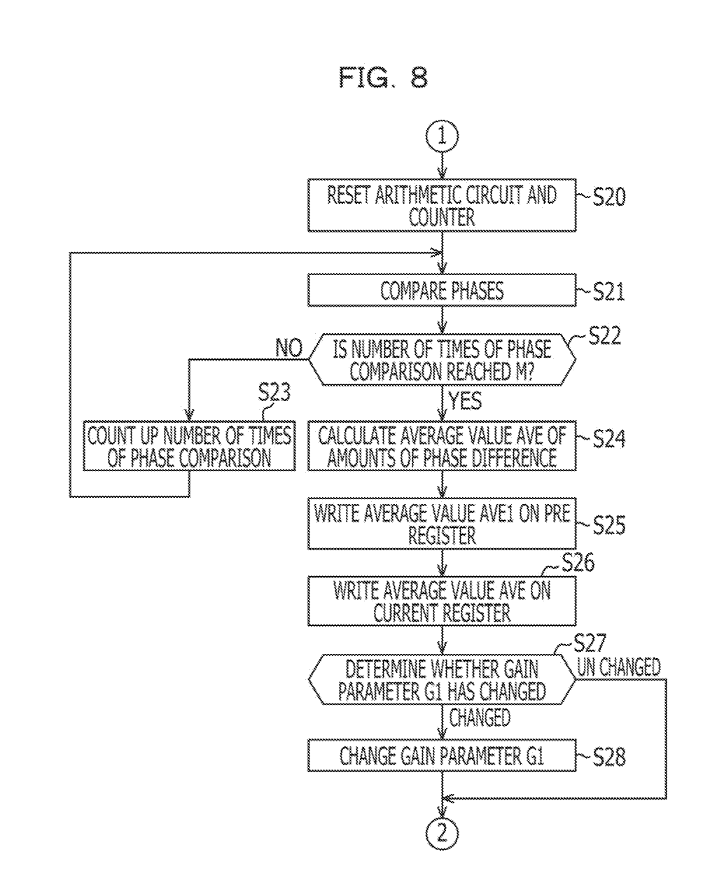

In the operation S17, the average value AVE calculated in the operation S16 is written in the current register 26. In the operation S18, the first decision circuit 25 determines whether the average value AVE is equal to or more than the reference value T1. If the average value AVE is equal to or more than the reference value T1, the initial value of the gain parameter G1a is not appropriate for the jitter amount. Therefore, the first decision circuit 25 changes the gain parameter G1a, for example, increases the gain parameter G1a in the operation A19. At the time of a first changing of the first gain parameter G1 after communication, the gain parameter G1 is changed based on the gain parameter G1a. Subsequently, the process proceeds to an operation S20 illustrated in FIG. 8.

If the average value AVE calculated in the operation S16 is less than the reference value T1 (“NO” in the operation S18), the initial value of the gain parameter G1a is a value suitable for the jitter amount. Therefore, the gain parameter G1a is not changed and the process proceeds to the operation S20. The information representing a change in gain parameter G1a, such as an increase or a no-change, is stored as the previous control information in the register 28a in the second decision circuit 28.

In the operation S20 illustrated in FIG. 8, the arithmetic circuit 21 and the counter 21a are reset. Operations S21 to S24 may be substantially the same as or similar to the operations 513 to 516 illustrated in FIG. 7. In the operation S24, the arithmetic circuit 21 calculates the average value AVE of the second and subsequent phase difference information D2 after starting the communication.

In an operation S25, the current average value AVE1 held in the current register 26 is written in the pre register 27. The previous average value AVE, for example the average value AVE of the first phase difference information D2 after starting the communication, is written in the pre register 27. The average value AVE calculated in the operation S24, for example the average value AVE of the second phase difference information D2 after starting the communication, is written in the current register 26.

In an operation S27, it is determined whether the gain parameter G1, for example the gain parameter G1b, is changed. For example, if the first decision circuit 25 determines that the average circuit AVE is less than the reference value T1, the initial value of the gain parameter G1 is a value suitable for the jitter amount. Thus, the gain parameters G1 and G1b are not changed and the process returns to the operation S20.

If the first decision circuit 25 determines that the average value AVE calculated in the operation S24 is equal to or more than the reference value T1, for example, the second decision circuit 28 changes the gain parameter G1b as illustrated in FIG. 6 in the operation S28. The second decision circuit 28 changes the gain parameter G1a so as to reduce the average value VE based on the previous control information of the gain parameter G1 and the result of the comparison between the current average value AVE1 and the pre average value AVE2. Since the gain parameter G1b is used in the second and subsequent change of the gain parameters G1 after starting the communication, the gain parameter G1 is changed based on a change in gain parameter G1b. Therefore, the second decision circuit 28 may change the gain parameter G1.

In the operation S19 illustrated in FIG. 7, the second decision circuit 28 may determine that the tracking characteristic of the CDR circuit 2 may be lowered due to the change when the current average AVE1, which is the phase difference after the change, is larger than the pre average value AVE2, which is the phase difference before the change. For example, it is determined that the value of the changed gain parameter G1 is not appropriate for the jitter amount of the receive data D1. At this time, for example, the second decision circuit 28 changes the gain parameter G1 so that the phase difference becomes small. For example, the second decision circuit 28 changes the gain parameter G1 in the direction opposite to the previous change. For example, the second decision circuit 28 changes the gain parameter G1 so that it becomes smaller than one before the change. The tracking characteristic of the CFR circuit 2 is changed appropriately due to the change of the gain parameter G1, and the average value AVE of the phase difference information D2 becomes small. The changed gain parameter G1 servers as an appropriate one for the jitter amount of the receive data D1.

The second decision circuit 28 determines that the tracking characteristic of the CDR circuit 2 may be improved due to the change when the current average AVE1, which is the phase difference after the change, is smaller than the pre average value AVE2, which is the phase difference before the change. The second decision circuit 28 changes the gain parameter G1 so that the phase difference becomes small. The second decision circuit 28 changes the gain parameter G1 so that it becomes higher than one after the change. The tracking characteristic of the CDR circuit 2 is improved and the average value AVE of the phase difference information D2 becomes small.

If the current average value AVE1 becomes larger that than the pre average value AVE2 due to the change of the gain parameter G1, the second decision circuit 28 changes the gain parameter G1 in the direction opposite to the previous change. If the current average value AVE1 becomes smaller than the pre average value AVE2 due to the change of the gain parameter G1, the second decision circuit 28 changes the gain parameter G1 in the direction opposite to the previous change.

If the average value of the phase difference information D2 after the change of the gain parameter G1 become larger than the average value of the phase difference information D2 after the change of the gain parameter G1 (AVE2<AVE1), the second decision circuit 28 changes the gain parameter G1 in the direction opposite to the previous change. For example, if the previous change of the gain parameter G1 is in the increasing direction, the gain parameter G1 is reduced. If the previous change of the gain parameter G1 is in the decreasing direction, the gain parameter G1 is increased. If the average value of the phase difference information D2 after the change of the gain parameter G1 becomes smaller than the average value of the phase difference information D2 after the change of the gain parameter G1 (AVE2>AVE1), the gain parameter G1 changes in the direction opposite to the previous change. For example, if the previous change of the gain parameter G1 is in the increasing direction, the gain parameter G1 is increased. If the previous change of the gain parameter G1 is in the decreasing direction, the gain parameter G1 is decreased. The change allows the gain parameter G1, such as the tracking characteristic of the CDR circuit 2, to approach a suitable value for the jitter amount of the receive data D1, thereby the average value AVE of the phase difference information D2 decreasing. The change of the gain parameter G1 is repeated until the average value AVE of the phase difference information D2 reaches less than the reference value T1 (operations S20 to S28).

If the gain parameter G1 is not changed and, for example, the pre average value AVE2 corresponding to the phase difference is less than the reference value T1, the second decision circuit 28 determines that the jitter amount of the receive data D1 has changed when the current average value AVE1 becomes larger than the pre average value AVE2. For example, it is determined that the tracking characteristic of the CDR circuit 2 deteriorates due to the change in jitter amount of the receive data D1. How the jitter amount of the received data D1 has changed may not be detected. The second decision circuit 28 changes the gain parameter G1 using a certain process. If the tracking characteristic of the CDR circuit 2 is deteriorated by such a change, the gain parameter G1 is changed in the opposite direction to improve the tracking characteristic of the CDR circuit 2. The average value AVE of the phase difference information D2 may become small.

If the pre average value AVE2 and the current average value AVE1 are substantially equal to each other, the second decision circuit 28 changes the gain parameter G1 by a method. For example, if the pre average value AVE2 and the current average value AVE1 are substantially equal to each other, there is no determination about whether the previous change is appropriate or not. Therefore, the second decision circuit 28 changes the gain parameter G1 by the method. Since the next change causes the gain parameter G1 to change in the opposite direction when the tracking characteristic of the CDR circuit 2 is deteriorated by the change, the tracking characteristic of the CDR circuit 2 may be improved. The average value AVE of the phase difference information D2 may become small.

In the operation S28, the gain parameter G1 is changed so that the average value AVE of phase difference information D2 becomes small. The process returns to the operation S20 and repeats the operations S20 to S28 until the communication is completed. The average value AVE of the phase difference information D2 becomes smaller than the reference value T1, the jitter amount of the CDR circuit 2, which is appropriate for the jitter amount of the receive data D1, may be defined.

The phase difference between the receive data D1 and the extraction clock CLK is monitored as a jitter amount, and the gain parameter G1 is changed so that the phase difference becomes small depending on a change between the phase difference before the change of the gain parameter G1 and the phase difference after the change of the gain parameter G1. If the jitter amount varies depending on the operating state or the like of the apparatus, the gain parameter G1 is changed according to the variation. Therefore, the gain parameter G1 is suitably set for the varying jitter amount and the tracking characteristic of the CDR circuit 2 suitable for the jitter amount may be set.

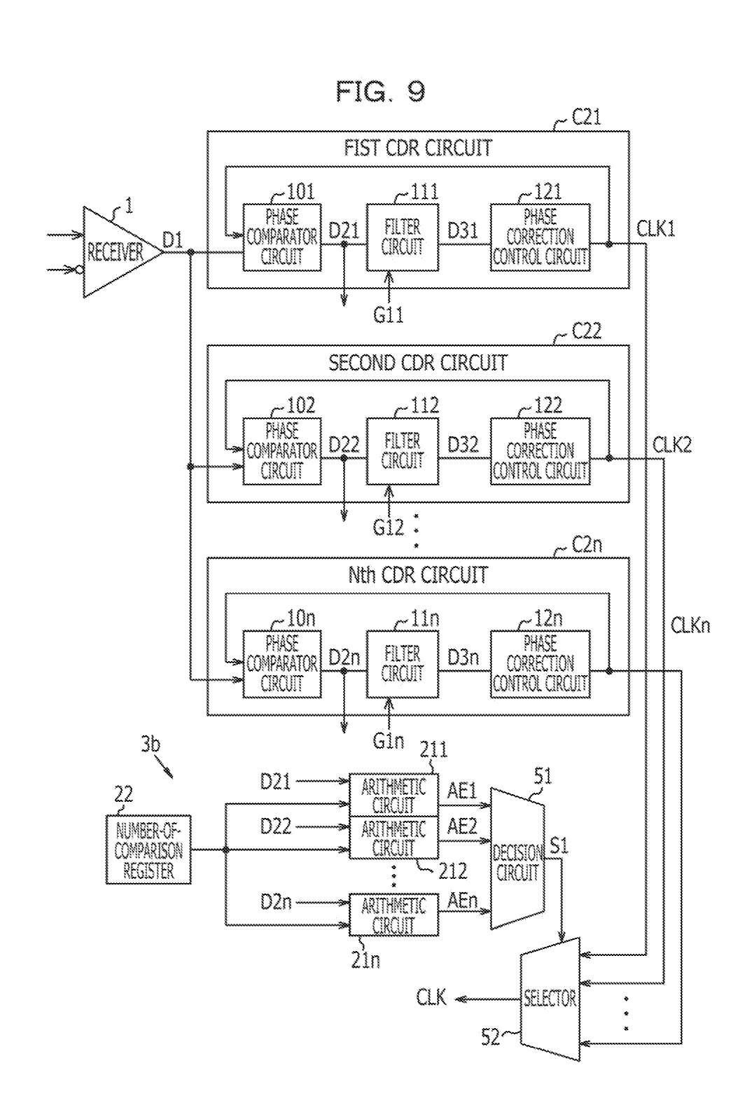

FIG. 9 illustrates an exemplary receiving apparatus. In FIG. 9, the components which is substantially the same as or similar to those illustrated in FIGS. 1 to 8 may be provided with the same reference numerals and the description may be omitted or reduced.

The receiving apparatus illustrated in FIG. 9 includes a receiver circuit 1, a plurality (n) of CDR circuits C2i (i=1, 2, . . . , n), and a gain setting circuit 3b. Similar to the CDR circuit 2 illustrated in FIG. 1, each of a plurality of CDR circuits C2i may include a phase comparator circuit 10i, a filter circuit 11i, and a phase correction control circuit 12i. Gain parameters G1i, which are different from one another, may be set in the filter circuits 11i of the respective CDR circuits C2i, respectively. Therefore, the CDR circuits C2i generate clock signals CLKi with different phases based on receive data D1 from the receiver circuit 1, respectively. For example, a first CDR circuit C21 generates a clock signal CLK1 according to a tracking characteristic set by a gain parameter G11 and a second CDR circuit C22 generates a clock signal CLK2 according to a tracking characteristic set by a gain parameter G12. The clock signal CLKi is supplied to a selector 52 in the gain setting unit 3b.

Since the phases of the clock signals CLKi generated by the phase correction control circuit 12i are different from one another, the phase comparator circuits 10i generate phase difference information D2i that includes different phase differences, respectively. For example, the phase comparator circuit 101 in the first CDR circuit C21 generate phase difference information D21 that includes the phase difference between the receive data D1 and the clock signal CLK1. The phase comparator circuit 102 in the second CDR circuit C22 generate phase difference information D22 that includes the phase difference between the receive data D1 and the clock signal CLK2. The phase difference information D2i is supplied to each of the arithmetic circuits 21i in the gain setting circuit 3b.

The gain setting circuit 3b selects a CDR circuit C2i among a plurality of the CDR circuit C2i, which has the least amount of phase difference, based on the phase difference information D2i from the respective CDR circuits C2i. The clock signal CLKi generated by the selected CDR circuit C2i is output as an extraction clock CLK. The extraction clock CLK may be supplied to a D-FF circuit 4 or a logic circuit 5, as illustrated in FIG. 1.

The gain setting circuit 3b includes n arithmetic circuits 21i for the respective CDR circuit C2i, a number-of-comparison register 22, a decision circuit 52, and a selector 52. Each arithmetic circuit 21i receives phase difference information D2i from the phase comparator circuit 10i in the corresponding CDR circuit C2i and a number M from the number-of-comparison register 22. Similar to the arithmetic circuit 21, each of the arithmetic circuits 21i calculates the average value AEi of M pieces of the phase difference information D2i, for example, 10 pieces, and outputs the average value AEi to the decision circuit 51. For example, the arithmetic circuit 211 calculates the average value AE1 of M pieces of the phase difference information D21 from the phase cooperator circuit 101 in the first CDR circuit C21. The arithmetic circuit 212 calculates the average value AE2 of M pieces of the phase difference information D22 from the phase cooperator circuit 102 in the second CDR circuit C22. The average value AE1 or AE2 is supplied to the L decision circuit 51.

The decision circuit 51 detects an average value AEi with the minimum phase difference by comparing a plurality of average values AEi supplied from the respective arithmetic circuits 21i each other. The decision circuit 51 generates a selection signal 51 for selecting the CDR circuits C2i, which corresponds to the arithmetic circuit that generates the average value AEi with the minimum phase difference, and outputs the selection signal 51 to the selector 52. The selector 52 selects one of clock signals CLKi from the respective CDR circuits C2i in response to the selection signal 51 and outputs it as an extraction clock CLK.

For example, if the decision circuit 51 determines that the phase difference of the average value AE1 among the average values AE1 to AEn is the smallest, a selection signal S1 for selecting the first CDR circuit C21 is supplied to the selector 52. The selector 52 selects a clock signal CLK1 generated by the first CDR circuit C21 among the clock signals CLK1 to CLKn in response to the selection signal S1, and outputs the clock signal CLK1 as an extraction clock CLK. The clock signal CLK1, which is generated by the first CDR circuit C21 corresponding to the gain parameter G11 with the minimum phase difference, is output as an extraction clock CLK. The clock signal CLK 1, which is generated according to the tracking characteristic corresponding to the gain parameter G11 suitable for the jitter amount of the receive data D1, is output as an extraction clock CLK.

The clock signal CLKi generated by the CDR circuit C2i having the lowest average value AEi (phase difference) is output as the extraction clock CLK. The relation between the jitter amount of the receive data D1 when the phase difference is the lowest and the gain parameter G1i (the tracking characteristic of the CDR circuit C2i) may be appropriate. Therefore, the clock signal CLK, which is generated by the CDR circuit having the gain parameter G1i suitable for the jitter amount to be varied by the operation state or the like of the apparatus, is output as an extraction clock CLK. The change and updating are performed for every M times, so that extraction clock CLK is generated.

Since the CDR circuit C2i with the lowest average value AEi is selected, the gain parameter G1i and the tracking characteristic of the CDR circuit C2i may be changed. The gain parameter G1i or the tracking characteristic of the CDR circuit C2i may be quickly set according to the jitter amount of the varying receive data D1.

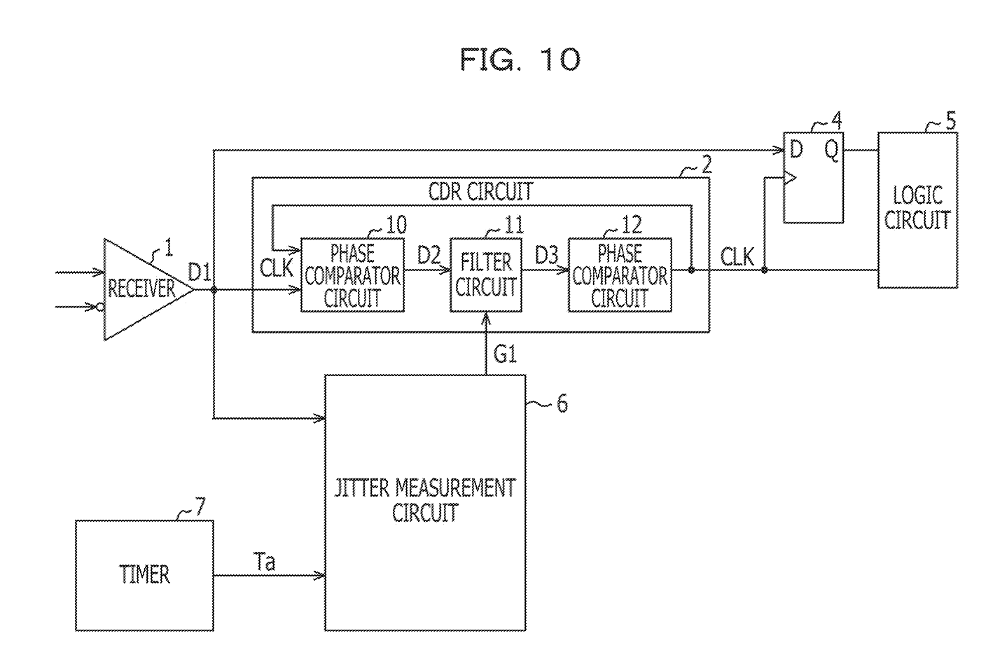

FIG. 10 illustrates an exemplary receiving apparatus. In FIGS. 10 to 15, elements, which are substantially the same as or similar to those illustrated in FIGS. 1 to 8, may be provided with the same reference numerals and the description may be omitted or reduced.

The receiving apparatus includes a receiver circuit 1, a CDR circuit 2, a D-FF circuit 4, a logic circuit 5, a jitter measurement circuit 6, and a timer 7. Receive data D1 output from the receiver circuit 1 is supplied to each of the CDR circuit 2, the D-FF circuit 4, and the jitter measurement circuit 6. A measurement period Ta from the timer 7 is supplied to the jitter measurement circuit 6.

The jitter measurement circuit 6 measures the jitter amount of the receive data D1 and sets the gain parameter G1 of a filter circuit 11 in the CDR circuit 2 depending on the amount of jitter of the receive data D1. For example, the jitter measurement circuit 6 may measure the maximum jitter amount within the measurement period Ta. Then, the jitter measurement circuit 6 may set the gain parameter G1 so that the gain parameter G1 serves as a tracking characteristic suitable for the maximum jitter amount.

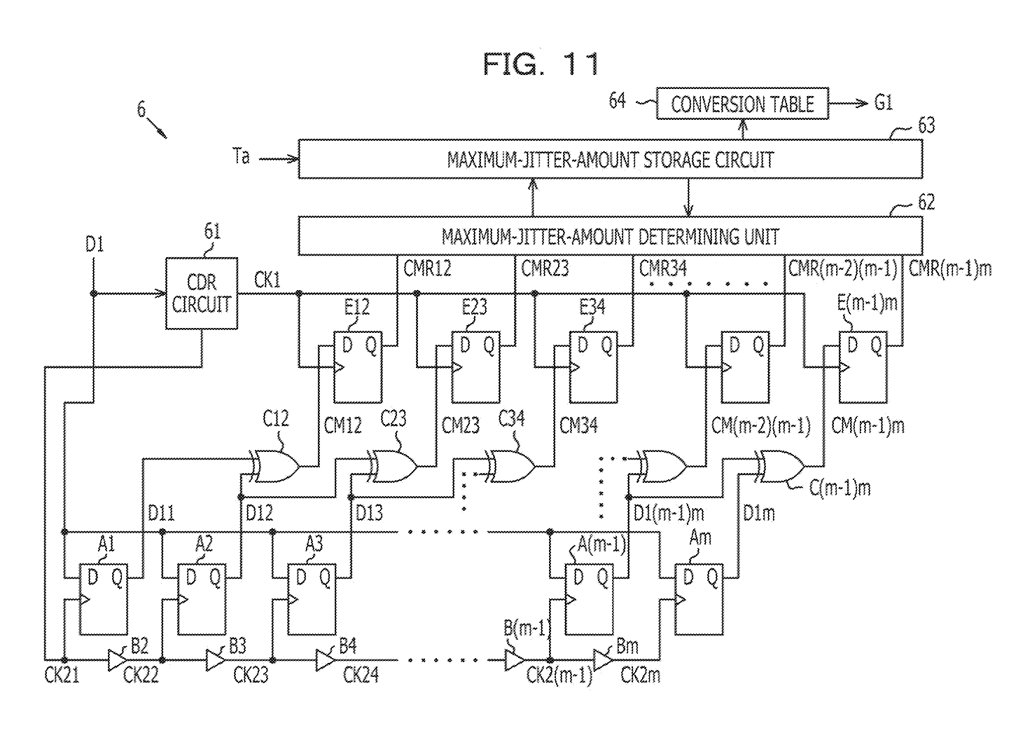

FIG. 11 illustrates an exemplary jitter measurement circuit. The jitter measurement circuit illustrated in FIG. 11 may be the jitter measurement circuit illustrated in FIG. 10. As illustrated in FIG. 11, the jitter measurement circuit 6 includes a CDR circuit 61, a plurality (for example, m) of D-FF circuits Aj (j=1, 2, . . . , m), and a plurality (for example, m−1) buffer circuits Bk (k=2, 3, . . . , m) coupled one another in series. The jitter measurement circuit 6 includes m−1 exclusive disjunction (EOR) circuits Cxy (x=1, 2, . . . , m−1, y=2, 3, . . . , m), m−1 D-FF circuits Exy, a maximum-jitter-amount determining unit 62, the maximum-jitter-amount storage circuit 63, and a conversion table 64.

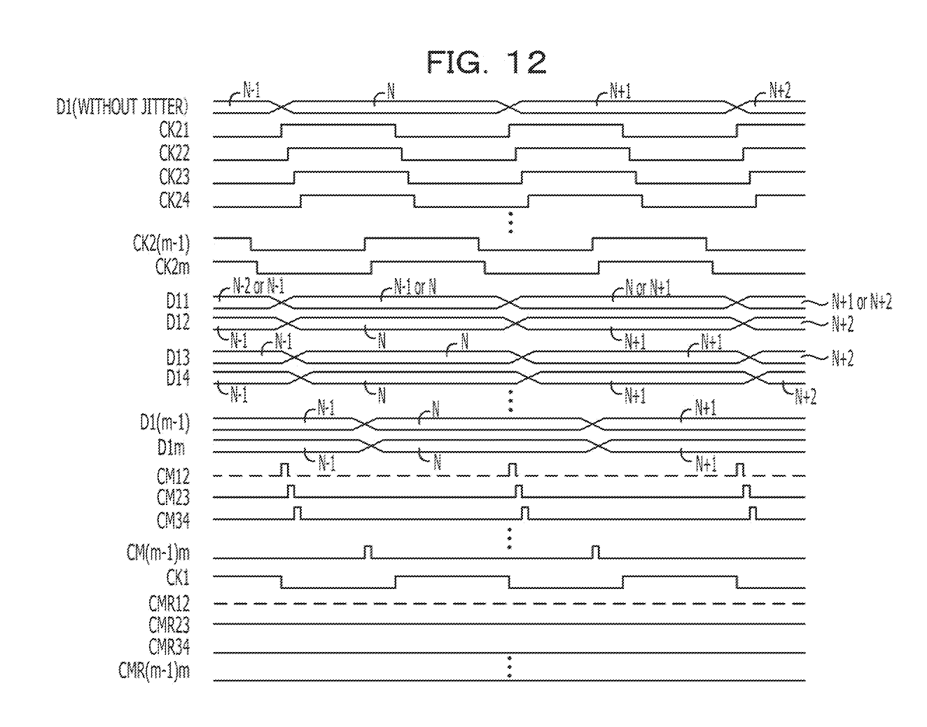

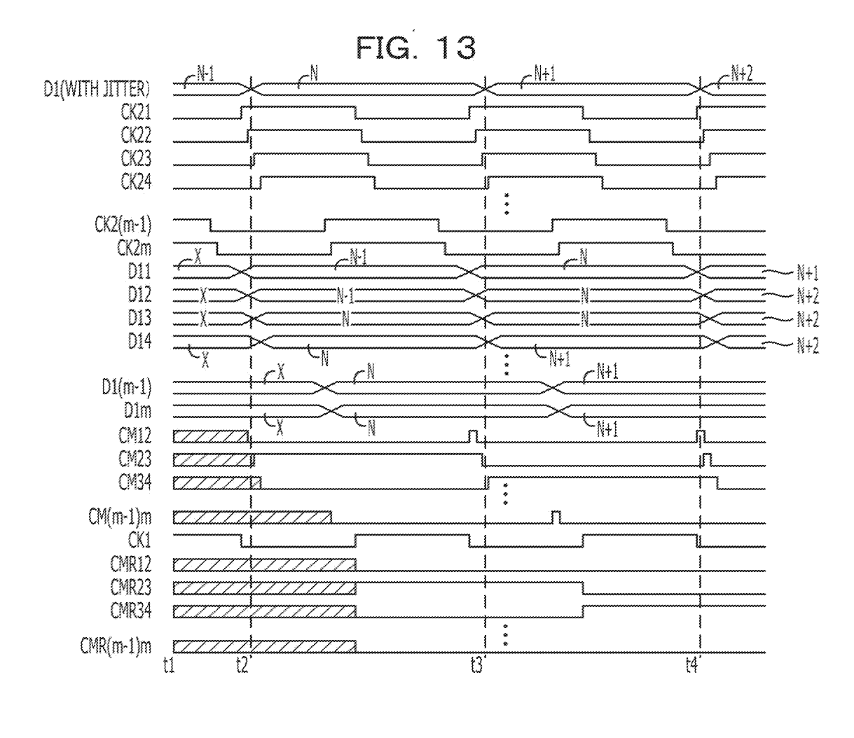

The CDR circuit 61 may include, but not illustrated in the figure, a phase comparator circuit, a filter circuit to which a gain parameter is set, and a phase correction control circuit. The CDR circuit 61 generates two clock signals CK1 and CK21 with different phases based on the receive data D1 from the receiver circuit 1. For example, as illustrated in FIG. 12, the CDR circuit 61 generates a clock signal CK1 so that the setup time and the hold time are ensured for the receive data D1, and an edge, such as a rising edge, is located on the substantially middle position of the receive data D1. As illustrated in FIG. 12, the CDR circuit 61 generates the clock signal CK 21 so that the rising edge is located at the data transition point of the receive data D1. The CDR circuit 61 generates clock signals CK1 and CK21 having their respective phases which are deviated about 180 degrees from each other. As illustrated in FIG. 11, the CDR circuit 61 outputs the clock signal CK1 to the clock terminal of the D-FF circuit Exy and also outputs the clock signal CK21 as a clock signal CK2j to each of the clock terminal of the D-FF circuit A1 and a buffer circuit B2 corresponding to a first stage of the buffer circuit Bk.

The buffer circuit B2 generates a clock signal CK22 which is delayed a certain time from the clock signal CK 21 and outputs the clock signal CK22 to each of the clock terminal of the D-FF circuit A2 and the next buffer circuit B2. Each of the subsequent buffer circuits Bk generates a clock signal CK2j which is obtained by delaying a clock signal CK2 (j−1) supplied from the previous buffer circuit B (k−1) for a certain time and outputs the clock signal CK2 (j−1) to the clock terminal of the D-FF circuit Aj and the next buffer circuit B (k+1). The last buffer circuits Bm generates a clock signal CK2m which is obtained by delaying a clock signal CK2 (m−1) supplied from the previous buffer circuit B (m−1) for a certain time and then outputs the clock signal CK2 (m−1) to the clock terminal of the D-FF circuit Am. Then, m clock signals CK2j, which are generated by the CDR circuit 61 and a plurality of buffer circuits Bk, have different phases from one another. The clock signal CK2j is generated so that the clock signal CK2m generated by the last buffer circuit Bm is raised earlier than the leading edge of the clock signal CK1 (see FIG. 12).

The receive data D1 is input in the data terminal of the D-FF circuit Aj and the clock signal CK2j is input in the clock terminal thereof. The D-FF circuit Aj outputs a signal corresponding to the receive data D1, which is input in the data terminal in synchronization with the leading edge of the clock signal CK2j, as data D1j. The D-FF circuit Aj samples the receive data D1 in response to clock signals CK2j having different phases from each other and then outputs the sampled data as data D1j. The output terminals of the adjacent D-FF circuits Ax and Ay (y=x+1) among the D-FF circuit Aj are coupled to the first and second input terminal of a single EOR circuit Cxy, respectively. The data D1x and D1y output from the adjacent D-FF circuits Ax and Zy are supplied to the EOR circuit Cxy. The data D1x sampled by the clock signal CK2x and the data D1y sampled by the clock signal CK2y are supplied to the EOR circuit Cxy, respectively. For example, the data D11 sampled by the clock signal CK21 in the D-FF circuit A1 and the data D12 sampled by the clock signal CK22 in the D-FF circuit A2 are supplied to the EOR circuit C12, respectively. The data D12 output from the D-FF circuit A2 and the data D13 output from the D-FF circuit A3 are supplied to the EOR circuit C23, respectively.

The EOR circuit Cxy compares the data D1x from the D-FF circuit Ax and the data D1y from the D-FF circuit Ay, where the D-FF circuits Ax and Ay are adjacent to each other. The EOR circuit Cxy outputs the signal CMxy at a low level is output to the data terminal of the D-FF circuit Exy when the data D1x matches the data D1y. The EOR circuit Cxy outputs the signal CMxy at a high level is output to the data terminal of the D-FF circuit Exy when the data D1x matches the data D1y.

The signal CMxy from the EOR circuit Cxy is input in the data terminal of the D-FF circuit Exy. The clock signal CK1 from the CDR circuit 61 is input in the clock terminal of the D-FF circuit Exy. The D-FF circuit Exy outputs a signal CMRxy corresponding to the signal CMxy, which is supplied to the data terminal in synchronization with the leading edge of the clock signal CK1, to the maximum-jitter-amount determining unit 62.

If the receive data D1 varies, the output of the D-FF circuit Aj varies according to the jitter amount of the receive data D1. For example, outputs of the D-FF circuits Ax and Ay, which sample using the clock signals CK2x and Ck2y which rise before and after timing according to the jitter amount respectively, may vary. Whether the output data D1x and D1y of the adjacent D-FF circuits Ax and Ay coincide with each other or not is determined and data transition between the edge of the clock signal CK2x and the edge of the clock signal CK2y is detected. The time from the rising of the clock signal CK2y to the rising of the clock signal CK2y where the data transition has occurred may be correspond to the jitter amount.

FIG. 12 and FIG. 13 illustrate an exemplary operation of a jitter measurement circuit. The operation illustrated in FIG. 12 illustrates the operation of the jitter measurement circuit illustrated in FIG. 10 when the receive data D1 does not include jitter. The operation illustrated in FIG. 13 illustrates the operation of the jitter measurement circuit 6 illustrated in FIG. 10 when the receive data D1 includes jitter. In each of FIG. 12 and FIG. 13, the vertical and horizontal axes may be arbitrarily extended or reduced to simplify the descriptions thereof, respectively.

In FIG. 13, since the receive data D1 includes jitter, the receive data D1 changes from (N−1) to (N) between the edge of the clock signal CK22 and the edge of the clock signal CK23.

As illustrated in FIG. 13, the clock signals CK21 and CK22 rise before time t2 when the receive data D1 changes, and the clock signals CK23 to CK2m rise after time t2. The D-FF circuit A1 outputs data D11 corresponding to the level (N−1) of the receive data D1 in synchronization with the leading edge of the clock signal CK21 to the EOR circuit C12. The D-FF circuit A2 outputs data D12 corresponding to the level (N−1) of the receive data D1 in synchronization with the leading edge of the clock signal CK22 to the EOR circuit C12. The D-FF circuit A3 outputs data D13 corresponding to the level (N) of the receive data D1 in synchronization with the leading edge of the clock signal CK23 to the EOR circuits C23 and C34.

Since the input data D11 and D12 coincide with each other after the data D12 corresponding to the level (N−1) is input, the EOR circuit C12 outputs the signal CM12 having a low level to the D-FF circuit E12.

After the data D13 corresponding to the level (N) is input, the data D12 corresponding to level (N−1) and the data D13 corresponding to level (N) are input in the EOR circuit C23. Since the data D12 and the data D13 do not coincide with each other, the EOR circuit C23 outputs the signal CM23 having a high level to the D-FF circuit E23. The signal CM23 having a high level may be output about until the next data transition point where the data D12 and D13 change. Since the input data D1x and D1y coincide with each other after the data D1y corresponding to level (N) is input, the EOR circuits Cxy subsequent to the EOR circuit C23 outputs a signal CMxy having a low level to the D-FF circuit Exy.

In the D-FF circuits Exy, the D-FF circuit E23, which receives the signal CM23 having a high level at the data terminal, outputs a signal CMR23 having a high level in synchronization with the leading edge of the clock signal CK1. Since a signal CMxy having a low level is supplied in the D-FF circuits Exy other than the D-FF circuit E23 when the clock signal CK1 rises, a signal CMRxy having a low level is output in synchronization with the leading edge of the clock signal CK1.

When the receive data D1 is changed between the edge of the clock signal CK22 and the edge of the clock signal CK23, the output data D12 of the D-FF cycle A2, which is sampled with the clock signal CK22, and the output data D13 of the D-FF cycle A3, which is sampled with the clock signal CK23, are different from each other. For example, when the output data D12 and D13 of the adjacent D-FF circuits A2 and A3 are different from each other, the data transition of the receive data D1 may be detected between the edge of the clock signal CK22 and the edge of the clock signal CK23. When the data D1x and D1y, which are output from the adjacent D-FF circuits Ax and Ay respectively, coincide with each other, the data transition of the receive data D1 is not detected between the edge of the clock signal CK2x and the edge of the clock signal CK2y.

In the D-FF circuits Exy, since the data D1x and D1y which are output from the adjacent D-FF circuits Ax and Ay respectively, are different from each other, the D-FF circuit Exy coupled to the EOR circuit Cxy, which outputs a signal CMxy having a high level, outputs a signal CMRxy having a high level Since the signal CMRxy having a high level is detected, the data transition of the receive data D1 is detected between the edge of the clock signal CK2x and the edge of the clock signal CK2y. For example, since the signal CMR23 having a high level may be detected, the data transition of the receive data D1 is detected between the edge of the clock signal CK22 and the edge of the clock signal CK23. When the transition of the receive data D1 is detected, outputs of the D-FF circuits A2 and A3, which respectively sample using the clock signals CK22 and Ck23 that rise before and after timing according to the jitter amount of the receive data D1, change. Therefore, the time from the rising of the clock signal CK21 to the rising of the clock signal CK23 may correspond to the jitter amount.

As illustrated in FIG. 12, if the receive data D1 does not include jitter, the timing of the data transition point of the receive data D1 and the timing of rising the edge of the clock signal CK21 substantially coincide with each other. Therefore, the data D1x and the data D1y to be input in the EOR circuit Cxy coincide with each other. The data D11 and the data D12 to be input in the first EOR circuit C12 are different from each other. Signals CMRxy having a low level may be output from all of the D-FF circuits Exy. Asignal CMR12 having a high level may be output only from the first D-FF circuit E12.

The signals CMRxy output from the D-FF circuits Exy and the maximum jitter amount stored in the maximum-jitter-amount storage circuit 63 are supplied to the maximum-jitter-amount storage circuit 62 illustrated in FIG. 11. The maximum-jitter-amount determining circuit 62 detects a signal having a high level from a plurality of signals CMRxy and determines the jitter amount based on the detected signal. For example, when the signal CMR23 supplied from the EOR circuit C23 is at a high level, the maximum-jitter-amount determining circuit 62 associates the time period from the rising of the clock signal CK21 to the rising of the clock signal CK23 with the jitter amount. The maximum-jitter-amount determining circuit 62 compares the jitter amount and the maximum jitter amount of the maximum-jitter-amount storage circuit 63. When the jitter amount is higher than the maximum jitter amount, the maximum-jitter-amount determining circuit 62 outputs the jitter amount as a new maximum jitter amount to the maximum-jitter-amount storage circuit 63.

The maximum-jitter-amount storage circuit 63 outputs the maximum jitter amount to be stored to the conversion table 64 and reset every time the measurement period Ta supplied from the timer 7 illustrated in FIG. 10 passes.

For example, the times t1 to t4 in FIG. 13 are defined as a measurement period Ta. At the times t2 to t3, the jitter amount determined based on the signal CMR 23 having a high level is initially stored as the maximum jitter amount in the maximum-jitter-amount storage circuit 63. Since the receive data D1 changes at the time t3 between the edge of the clock signal CK23 and the edge of the clock signal CK24, the output data D13 and D14 of the adjacent D-FF circuits A3 and A4 are different from each other during the times t3 to t4. The EOR circuit C34 outputs a signal CM34 having a high level and the D-FF circuit E34 outputs a signal CMR34 having a high level in synchronization with the leading edge of the first clock signal CK1. The decision circuit 62 associates the time period from the rising of the clock signal CK21 to the rising of the clock signal CK24 with the jitter amount based on the signal CMR 34 having a high level. The decision circuit 62 determines that the jitter amount based on the signal CMR34 having a high level is higher than the maximum jitter amount from the storage circuit 63, for example the jitter amount based on the signal CMR23 having a high level, and the decision circuit 62 outputs a large jitter amount as a new maximum jitter amount to the storage circuit 63. The storage circuit 63 outputs the jitter amount based on the signal CMR34 having a high level as the maximum jitter amount to the conversion table 64.

The conversion table 64 illustrated in FIG. 11 converts the maximum jitter amount output from the storage circuit 63 into a gain parameter G1 and outputs the gain parameter G1 to the filter circuit 11 in the CDR circuit 2 illustrated in FIG. 10. The conversion table 64 includes a table by which the jitter amount of the receive data D1 is associated with the gain parameter G1. For example, in the conversion table 64, the more the jitter amount of the receive data D1 illustrated in FIG. 4B increases the more the gain parameter G1 increases. The gain parameter G1 is changed depending on the jitter amount of the receive data D1 being changed.

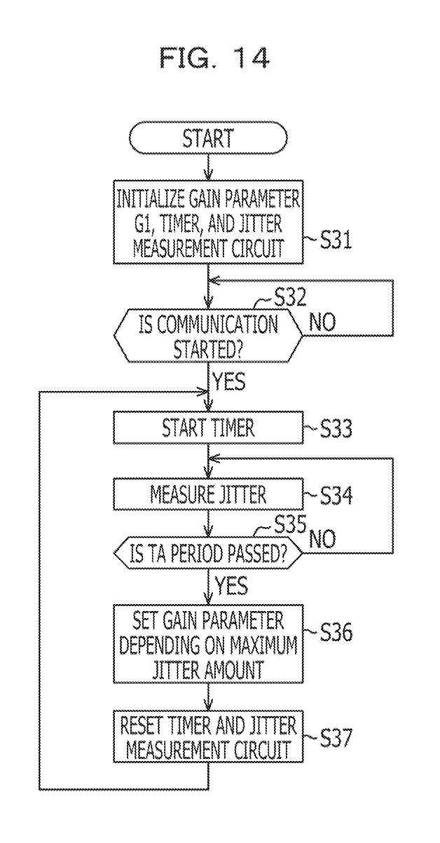

FIG. 14 illustrates an exemplary method for setting a gain parameter. As illustrated in FIG. 14, for example, the gain parameter G1 or the tracking characteristic of the CDR circuit 2 of the receiving apparatus illustrated in FIG. 10 may be set. Before starting communication, the gain parameter G1, the jitter measurement circuit 6, and the timer 7 may be initialized in an operation S31. The process waits for the start of communication in an operation S32. When the communication is started (“YES” in the operation S32), the timer starts to count the measurement period Ta in an operation S33.

The jitter measurement circuit 6 measures the jitter amount of the receive data D1 in an operation S34. In an operation S35, it is determined whether the measurement period Ta lapses. The measurement of the maximum jitter amount continues in the operations S34 and S35 until the measurement period Ta lapses. When the measurement period Ta lapses (“YES” in the operation S35), the gain parameter G1 depending on the maximum jitter amount in the measurement period Ta is set in an operation S36. The conversion table 64 converts the maximum jitter amount output from the storage circuit 63 into the gain parameter G1. The gain parameter G1 is set in the filter circuit 11. The gain parameter G1 which is suitable for the jitter amount of the receive data D1 is set. The tracking characteristic of the CDR circuit 2 which is suitable for the jitter amount of the receive data D1 is set.

In an operation S37, both the jitter measurement circuit 6 and the timer 7 are reset and the process reruns to the operation S33. In the operation S33, the count operation of the timer 7 is started again. In the operations S34 to S37, the gain parameter G1 depending on the maximum jitter amount in the measurement period Ta is set again. A series of the above operations change the gain parameter G1 depending on the jitter amount in every measurement period Ta. The tracking characteristic of the CDR circuit 2 corresponding to the jitter amount, which changes based on the operation state of the apparatus is set.

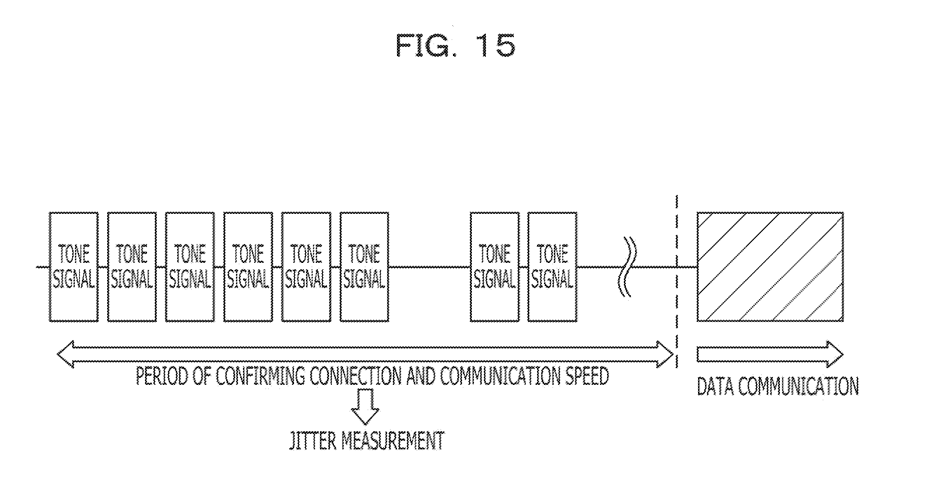

FIG. 15 illustrates an exemplary jitter measurement. For example, in a serial interface, such as IEEE1394-2008, the data communication may be performed at high speeds of 125 Mbp to 4 Gbps as illustrated in FIG. 15. Before starting the data communication, the connection between the devices, the communication speed, or the like is confirmed by transmission/reception of tone signals at low speed. During the period of communication at low speed, the jitter measurement is performed using the jitter measurement circuit 6 represented in the operations S3 to S5. Thus, the jitter amount of the receive data D1 is measured, while the gain parameter G1 is set in the operation S6. Since 48 to 64 MHz clock signals are used in the low-speed communication, the CDR circuit 61 in the jitter measurement circuit 6 may generate clock signals CK1 and CK21 with frequencies of 48 MHz to 64 MHz.

The gain parameter G1 according to the jitter amount of the receive data D1 to be measured based on the receive data D1 is set. Since the gain parameter G1 is changed according to the jitter amount of the receive data D1, the accuracy of a change in gain parameter G1 may be improved.

The initial value of the gain parameter G1 is set to a small value so that the tracking characteristic of CDR circuit 2 may become small. For example, the initial value of the gain parameter G1 may be set to a large value so that the tracking characteristic of CDR circuit 2 may become large. The decision circuit 24 lowers the gain parameter G1 to make the average value AVE smaller when the average value AVE is equal to or more than the reference value T1.

The initial value of the gain parameter G1a may be set to a small value so that the tracking characteristic of the CDR circuit 2 becomes small. Alternatively, the initial value of the gain parameter G1a may be set to a large value so that the tracking characteristic of the CDR circuit 2 becomes large.

Each of the average values AVE and AEi of the phase difference information D2 and D2i, which are respectively generated by the phase comparator circuits 10 and 10i, is monitored as a jitter amount of the receive data D1. For example, the average value AVE of the phase difference information D2 which is generated in the phase comparator circuit 10 is compared with the reference value T1. For example, the phase difference information D2 which is generated in the phase comparator circuit 10 may be compared with the reference value T1.

The average values AEi of the phase difference information D2i which is generated by the phase comparator circuit 10i are compared with one another, and the CDR circuit C2i having the minimum phase difference is selected. Alternatively, the average values AEi of the phase difference information D2i which is generated by the phase comparator circuit 10i may be compared with one another, and the CDR circuit C2i having the minimum phase difference may be selected.

For example, a change range of the gain parameter G1, for example, a rate of increase or a rate of decrease, may be changed. For example, the change range of the gain parameter G1 may be changed based on the amount of the average value AVE of the phase difference information D2, for example, the phase difference information D2. When the average value AVE is equal to or more than the reference value T1, the more the difference between the average value AVE and the reference value T1 increases the more the change range may be increased by the decision circuit 24 to increase the gain parameter G1. The gain parameter G1 may be quickly set to a suitable value.

Alternatively, the range of the gain parameter G1 may be changed depending on the communication partner. The reference value T1, the number of determinations M, or the measurement period Ta may be defined from an outside of the apparatus.

The configuration of jitter measurement circuit 6 may be arbitrary. The jitter measurement circuit 6 may measure the jitter amount of the receive data D1.

The configurations of the CDR circuits 2 and 2i may be arbitrary. For example, the filter circuits 11 and D11i may be replaced with analog filters, respectively. The data to be input in the receiver circuit 1 may be differential serial data or single-ended serial data.

All examples and conditional language recited herein are intended for pedagogical objects to aid the reader in understanding the invention and the concepts contributed by the inventor to furthering the art, and are to be construed as being without limitation to such specifically recited examples and conditions. Although the embodiment(s) of the present inventions have been described in detail, it should be understood that the various changes, substitutions, and alterations could be made hereto without departing from the spirit and scope of the invention.

1. A receiving apparatus, comprising:
a clock-data recovery circuit to generate a clock based on receive data; and
a setting circuit to set a gain of a filtering process to filter a phase difference between the receive data and the clock.

2. The receiving apparatus according to claim 1, wherein the setting circuit includes a monitor circuit to monitor the phase difference as the jitter amount.

3. The receiving apparatus according to claim 1, wherein the setting circuit includes a monitor circuit to monitor an average value of a plurality of phase differences between the receive data and the clock as the jitter amount.

4. The receiving apparatus according to claim 2, wherein the setting circuit changes the gain so that the phase difference becomes small based on an initial gain when the phase difference is equal to or more than a value.

5. The receiving apparatus according to claim 2, wherein the setting circuit changes the gain so that the phase difference becomes small based on a change in phase difference before and after the change of the gain when the phase difference is equal to or more than a value.

6. The receiving apparatus according to claim 3, wherein the setting circuit changes the gain so that the phase difference becomes small based on an initial gain when the phase difference is equal to or more than a value.

7. The receiving apparatus according to claim 3, wherein the setting circuit changes the gain so that the phase difference becomes small based on a change in phase difference before and after the change of the gain when the phase difference is equal to or more than a certain value.

8. The receiving apparatus according to claim 1, wherein when a second phase difference between the receive data and the clock corresponding to a second gain is smaller than a first phase difference between the receive data and the clock corresponding to a first gain, the setting circuit sets a third gain having a difference in a first direction for the second gain having a difference in the first direction for the first gain to the gain.

9. The receiving apparatus according to claim 1, wherein when a second phase difference between the receive data and the clock corresponding to a second gain is larger than a first phase difference between the receive data and the clock corresponding to a first gain, the setting circuit sets a third gain having a difference in a direction opposite to a first direction for the second gain having a difference in the first direction for the first gain to the gain.

10. The receiving apparatus according to claim 1, wherein the clock-data recovery circuit includes a plurality of first clock-data recovery circuits having different gains respectively, and
the setting circuit includes a selection circuit to select a first clock data recovery circuit that generates a clock with a reduced phase difference from among the plurality of the first clock data recovery circuits.

11. The receiving apparatus according to claim 1, wherein
the setting circuit includes a jitter measurement circuit that sets the gain depending on the measured jitter amount.

12. The receiving apparatus according to claim 11, wherein the jitter measurement circuit includes:
a second clock-data recovery circuit to output a first clock and a second based on the receive data;
a plurality of flip-flop circuits to sample the receive data using a plurality of clocks obtained by delaying the second clock;
a logic circuit to perform an exclusive OR operation on outputs from the plurality of the flip-flop circuits;
a circuit to measure a jitter amount at a time when the output from the flip-flop circuit changes by sampling the output from the logic circuit using the first clock; and
a conversion table to convert the measured jitter amount into the gain.

13. A method of setting a gain, comprising:
generating a clock based on receive data; and
setting a gain of a filtering process to filter a phase difference between the receive data and the clock depending on a jitter amount of the receive data.
